(19) United States
(12) Patent Application Publication
(10) Pub. No.: US 2007/0053766 A1
(43) Pub. Date: Mar. 8, 2007

(54) Screw for assembling aluminum doors/windows

(76) Inventor: Chen-Feng Lin, Jhonghe-City (TW)

Correspondence Address: Troxell Law Office Pllc;Suite 1404, 5205 Leesburg Pike, Falls Church, VA, 22041, US

(21) Appl. No.: 11/217,497

(22) Filed: Sep. 2, 2005

(51) Int. Cl. F16B 35/00

(52) U.S. Cl. 411/389

(57) ABSTRACT

A screw for assembling aluminum doors/windows, which is integrally formed with a bolt and a nut. The bolt has exterior threads, and is provided at its bottom end With a taper. Threads of a diameter greater than the other threads are provided adjacent to the taper, while a rugged surface having unidirectional ratchets is provided on the top surface of the nut. A hexagonal hole is provided on the bolt top such that when the bolt is collocated with an anti-loose nut for fastening the vertical and horizontal frames of the aluminum door/window to form a doorframe/window frame, it will be convenient for one to adjust the height of the side frames.

### BACKGROUND OF THE INVENTION

(a) Field of the Invention

The present invention relates to a screw design, which is integrally formed with a nut on the bolt, so that when the screw is assembled to the vertical and horizontal frames of an aluminum doorframe/window frame, it will be easy to adjust the height of the horizontal frames and allow them to be applied to the structure of the aluminum doors/windows.

(b) Description of the Prior Art

Generally, an aluminum door/window is in form of a rectangle composed of vertical and horizontal frames which used to lock together via screws. FIGS. 7 to 9 show assembly of a conventional doorframe/window frame, wherein a window frame is composed of at least vertical frames 50 and horizontal frames 51 formed by aluminum extrusion. Screw holes 52 are provided on the vertical frames 50, while through holes 53 are provided on the horizontal frames 51, and a hole 54 (as shown in FIG. 8) is further provided on the horizontal frames 51 beneath the through holes 53. In assembly, the screw 55 is firstly screwed with an adjustable nut 56 on the exterior threads. The tale 57 at the bottom of the screw 55 is inserted and screwed into the screw hole 56. A flare nut wrench 40 is inserted into the hexagonal hole 59 provided at the top of the screw 55 to lean against the vertical frame 50, such that the screw 55 will go through the hole 54 and be screwed with an anti-loose nut 59 to accomplish a corner formed with the vertical and horizontal frames of the window.

When one intends to adjust the height of the horizontal frame 51 end, he/she can utilize a flare nut wrench 40 to insert into the hexagonal hole 58 on the top of the screw and reverse the flare nut wrench 40. However, when the flare nut wrench 40 is reversed to raise the screw 55, the adjustable nut 56 provided on the frame will easily go far from synchronism with the reversion of the screw 55 due to the rugged surface of the cut surface A on the vertical frame 50. As such, the reversion of the screw 55 will form a gap B above the hole 54, and hence there exists difficulty in adjusting a required height for raising the horizontal frame 51, rendering the window frame structure imperfect.

In view of the above, the inventor has endeavored to improve the prior art and provided a screw that is integrally formed with a nut which has a rugged surface formed with unidirectional ratchets. Thereby, after the screw is fastened into the doorframe/window frame, one can utilize a flare nut wrench to insert into the hexagonal hole on the top of the screw to micro-adjust the height of the doorframe/window frame.

### SUMMARY OF THE INVENTION

The primary object of the invention is to provide a screw for assembling aluminum doors/windows, which is integrally formed with a nut, such that when the bolt is collocated with an anti-loose nut for fastening the doorframes/window frames, the height of the door/window frames can be adjusted by way of controlling the revolution of the bolt axis. Application of the invention to the aluminum doors/windows can efficiently ease the micro-adjusting process.

Another object of the invention is to provide a screw for assembling aluminum doors/windows, which is integrally formed with a nut which has a rugged surface on the top surface for enhancing the combination force between the screw and the doors/windows. When the bolt axis is revolving, the rugged surface of the nut would engender a resistance, thereby allowing micro-adjustment of the height of the doorframes/window frames.

A further object of the invention is to provide a screw for assembling aluminum doors/windows. Threads of a greater diameter in comparison to the other threads provided at the bottom of the bolt, such that when the screw is fastened to the screw hole of the aluminum frames, the lower bolt of the screw can engage with the screw hole firmly, and that the user can easily reverse the upper bolt of the screw to make micro-adjustment.

To obtain the above objects, the screw for assembling aluminum doors/windows according to the invention is integrally formed with a bolt and a nut. The bolt has exterior threads, and is provided at its bottom end with a taper. Threads of a greater diameter in comparison to the other threads are provided adjacent to the taper, while a rugged surface having unidirectional ratchets is provided on the top surface of the nut. A hexagonal hole is provided on the bolt top such that when the bolt is collocated with an anti-loose nut for fastening the vertical and horizontal frames of the aluminum door/window to form a doorframe/window frame, it will be convenient to adjust the height of the side frames.

To completely appreciate these and other objects of the present invention as well as the invention itself, all of which Will become apparent to those skilled in the art, the following detailed description of the invention and the claims should be read in conjunction with the accompanying drawings.

### BRIEF DESCRIPTION OF THE DRAWINGS

FIG. 1 is a perspective view of the present invention.

FIG. 2 is an exploded view of a window frame in an embodiment of the present invention.

FIG. 3 is a cut-away view showing a use status of the invention.

FIG. 4 is a cut-away view showing another use status of the invention.

FIG. 5 is a perspective view showing a use status of the invention.

FIG. 6 shows the window frames assembled via the present invention.

FIG. 7 is ah exploded view of the window frames assembled via the conventional screws.

FIG. 8 is a cut-away view showing a use status of the prior art.

FIG. 9 is a cut-away view showing another use status of the prior art.

FIG. 10 is a perspective view of another embodiment of the invention.

### DETAILED DESCRIPTION OF THE PREFERRED EMBODIMENTS

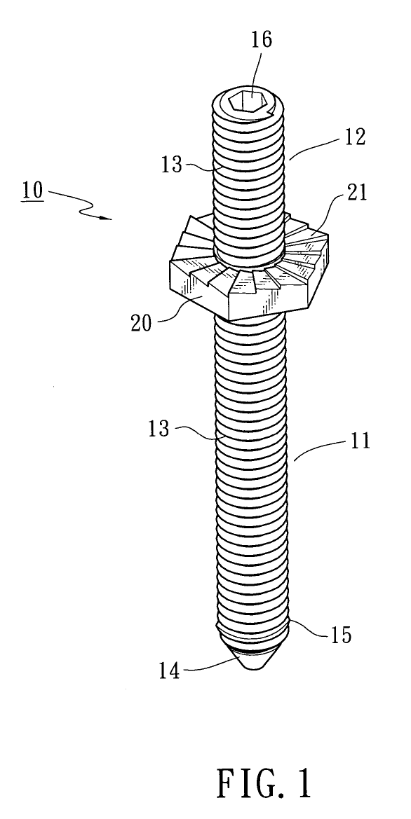

Referring to FIG. 1, a screw 10 for assembling aluminum doors/windows is formed integrally with a bolt 11 and a nut 20, wherein based on the nut 20, the screw 10 is divided into a lower bolt 11 and an upper bolt 12, on the wall of which is provided with pluralities of exterior threads 13. The lower bolt 11 is provided on its bottom end with a taper 14, adjacent to which is provided with threads of a greater diameter 15 in comparison to the other threads, and provided on its top end a hexagon hole 16. There is a rugged surface 21 on the top surface of the nut 20 and in the preferred embodiment, the rugged surface 21 is provided with unidirectional ratchets which are in a direction identical to that the exterior threads 13 swirl. When the rugged surface 21 is formed by tapers or extruding dots, the desired effect can be obtained as well. The threads of a greater diameter 15 are about 0.1 mm greater than that of the other threads on the lower bolt 11 in size.

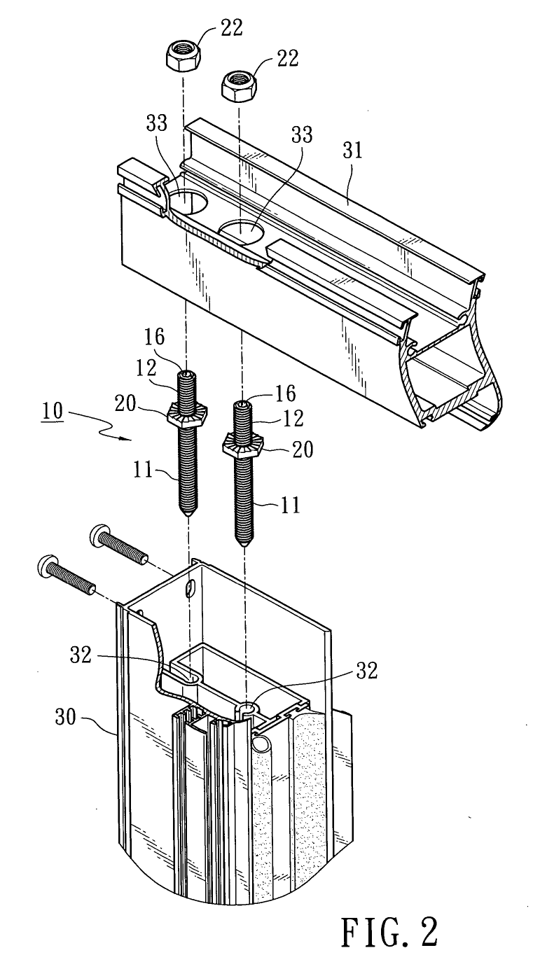

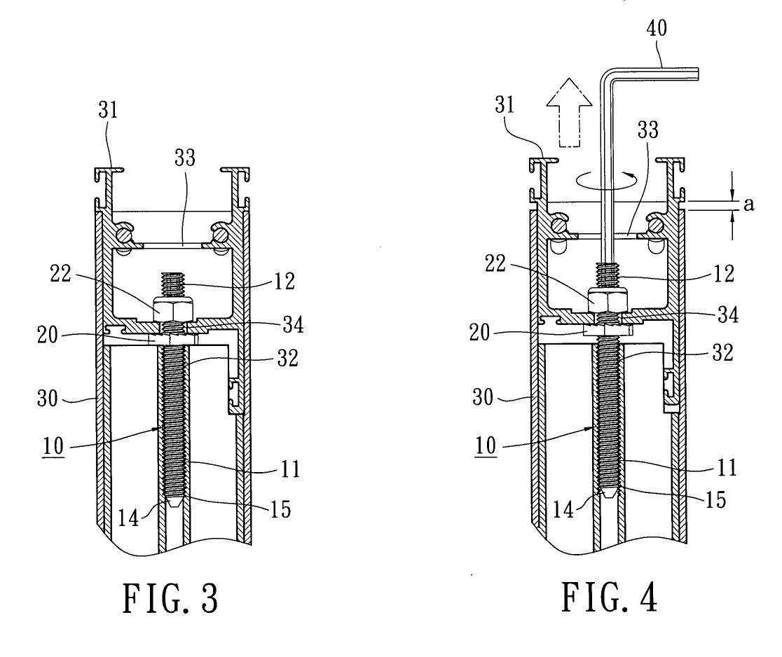

As shown in FIGS. 2 and 3, the screw 10 according to the invention is applied to the vertical frames 30 and horizontal frames 31 of aluminum doors/windows. While each of the vertical frames 30 is provided with screw holes 32, when the horizontal frames 31 is mounted on the top of the vertical frames 30, the horizontal frames 31 must be drilled to form through holes 33 and holes 34 beneath the through holes 33 (see FIG. 3) for receiving the upper bolts 12. In assembly, the lower bolt 11 of the screw 10 is firstly inserted into the screw hole 32 which is formed by aluminum extrusion with provided with interior threads. The screw 10 with exterior threads 13, which is formed by a material relatively harder than aluminum, is inserted into the screw hole 32 by force to generate a threading effect in the screw hole 32. The bottom of the lower bolt 11 is provided with pluralities of threads of a greater diameter 15 in comparison to the other threads, the number of which is about 1 to 3. When the screw 10 is fastened to the screw hole 33, the threads of a greater diameter 15 will make greater threads on the screw hole 33, such that the other exterior threads 13 on the screw 10 can be easily screwed into the screw hole 33. In the case of adjustment, a flare nut wrench 40 can be utilized to insert into the hexagonal hole 16 for the user to manually raise the screw 10 by easily reverse the flare nut wrench 40 without hurting the hand.

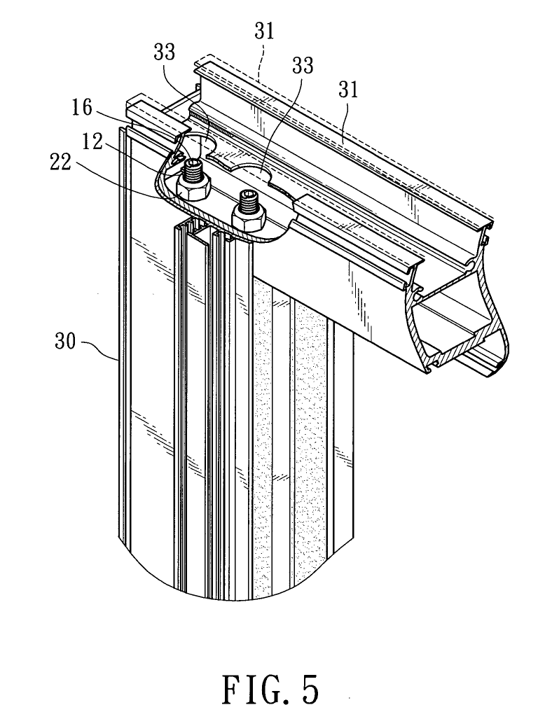

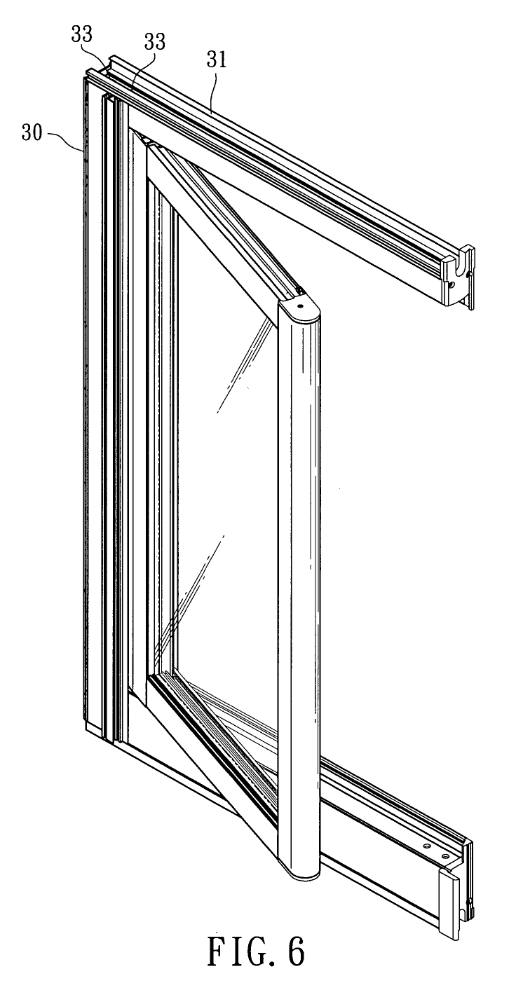

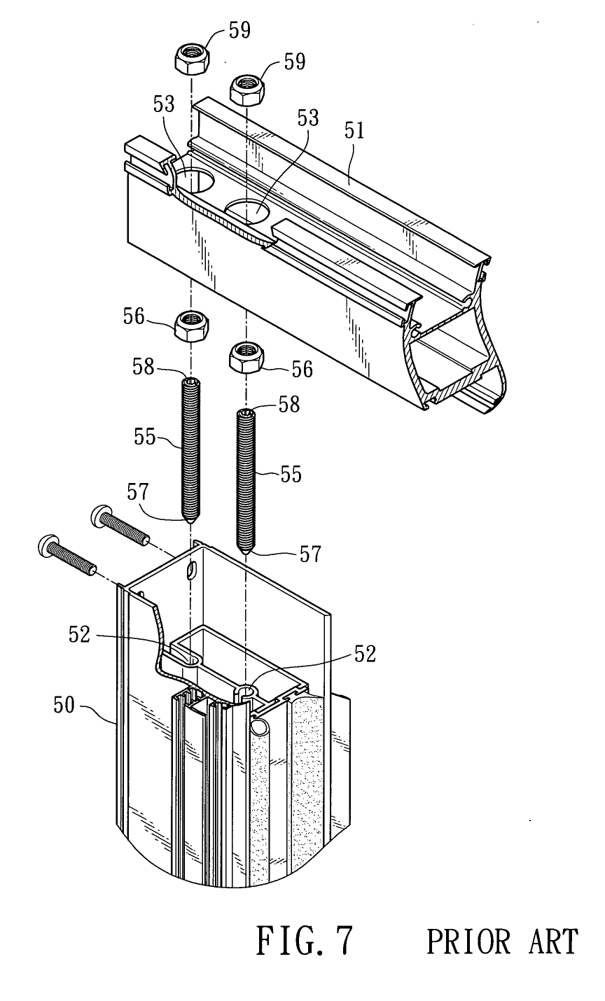

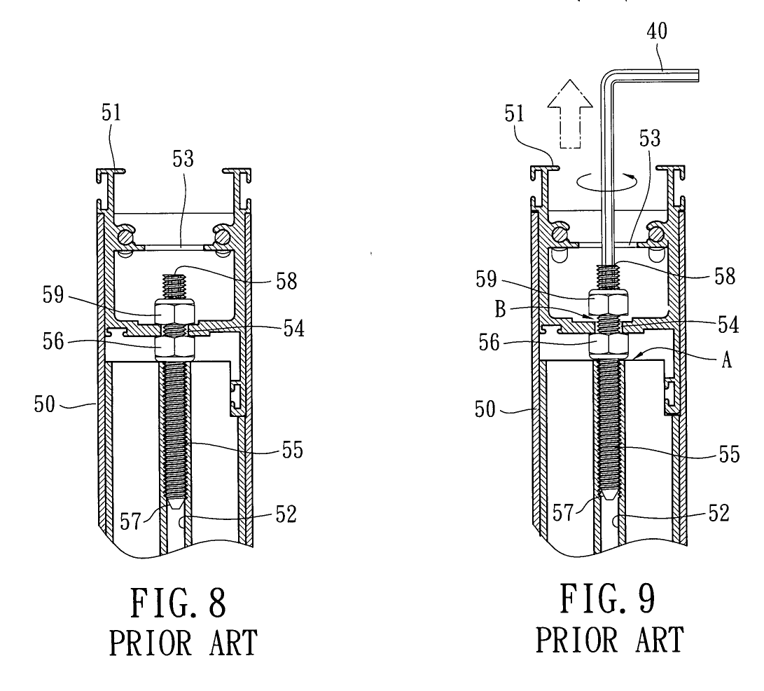

As shown in FIGS. 3 to 6, when the screw 10 is screwed into the screw hole 32 until the nut 20 leans against the vertical frame 30 of the window, such that the upper bolt 12 goes through the hole 34, and then is screwed with an anti-loose nut 22, to accomplish assembly of a C-type window frame. In view of the fact that the combination intensity at the corners of the C-type window frame is of the most importance, and that adjustment of the horizontal frames 31 requires precision and convenience, the flare nut wrench 40 is utilized to insert into the hexagonal hole 16 at the top of the screw 10 for reversing to raise the screw 10 at a distance a, such that the required height can be precisely and easily obtained. Accordingly, an appropriate height of the horizontal frames can allow the window to slide on the frame rail smoothly.

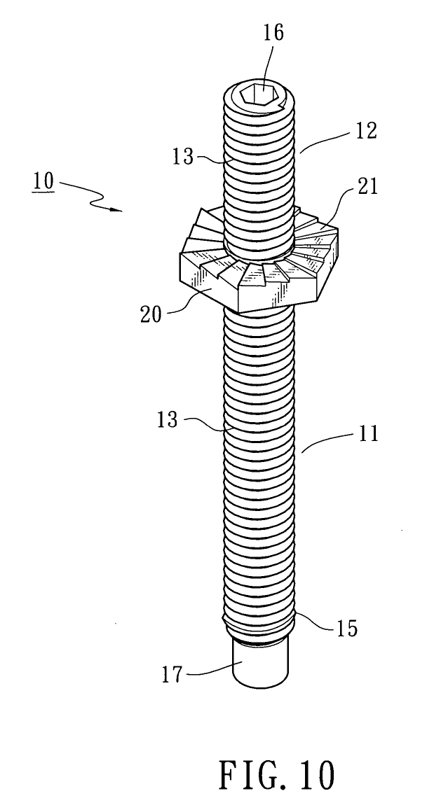

Referring to FIG. 10, showing another preferred embodiment of the invention, based on the nut 20, the lower section of the screw 10 is defined as a lower bolt 11 which is provided beneath the threads of a greater diameter 15 with a guide rod 17 having a smaller diameter in comparison than the other threads to ease the screw 10 to aim at the screw hole 32.

Concluded above, the screw according to the invention can provide a precise and convenient process for adjusting the height of the doorframe/window frame after the screws are screwed onto the aluminum door/window. While certain novel features of this invention have been shown and described and are pointed out in the annexed Claims, it is not intended to be limited to the details above, since it will be understood that various omissions, modifications, substitutions and changes in the forms and details of the device illustrated and in its operation can be made by those skilled in the art without departing in any way from the spirit of the present invention.

What is claimed is:

1. A screw for assembling aluminum doors and windows, which is integrally formed with a bolt provided with exterior threads, comprising:
a nut integrally formed on the bolt between the upper bolt and lower bolt, while the bottom of the lower bolt is provided with pluralities of threads of a greater diameter in comparison to the other threads, the upper surface of the nut has a rugged surface, and there is a hexagonal hole on the top of the bolt.

2. The screw for assembling aluminum doors and windows according to claim 1, wherein a taper is provided at the bottom end of the lower bolt.

3. The screw for assembling aluminum doors and Windows according to claim 1, wherein a guide rod having a diameter smaller than the threads is provided at the bottom end of the lower bolt.

4. The screw for assembling aluminum doors and windows according to claim 1, wherein unidirectional ratchets on the rugged surface on the nut top are in a direction identical to that the exterior threads swirl.

5. The screw for assembling aluminum doors and windows according to claim 1, wherein the rugged surface on the nut top can be formed by extruding tapers.

6. The screw for assembling aluminum doors and windows according to claim 1, wherein the rugged top surface of the nut can be formed by extruding dots.

7. The screw for assembling aluminum doors and Windows according to claim 1, wherein the threads of a greater diameter are about 0.1 mm greater than that of the other threads in size.
